(19) United States
(12) Patent Application Publication
(10) Pub. No.: US 2008/0228731 A1
(43) Pub. Date: Sep. 18, 2008

(54) DEBUGGING SYSTEM AND DEBUGGING METHOD

(76) Inventor: KENJI KANEMURA, Tokyo (JP)

Correspondence Address: NEC CORPORATION OF AMERICA, 6535 N. STATE HWY 161, IRVING, TX, 75039, US

(21) Appl. No.: 12/037,521

(22) Filed: Feb. 26, 2008

(30) Foreign Application Priority Data
Mar. 1, 2007 (JP) 2007-051086

(51) Int. Cl. G06F 7/06; G06F 17/30

(52) U.S. Cl. 707/3; 707/E17.014

(57) ABSTRACT

A debugging system includes a plurality of computers. Each of the plurality of computers includes a process data storage section; and a debug control section configured to collect process data of a process executed on the computer and to store the process data in the process data storage section of the computer. One of the plurality of computers as a specific computer includes a searching section configured to search satisfactory process data, which meets a search condition designated by a user, of the process data stored in the process data storage sections of the plurality of computers, and to display the satisfactory process data on a display unit.

This patent application is based on Japanese Patent application No. 2007-051086 filed Mar. 1, 2007. The disclosure thereof is incorporated herein by reference.

### TECHNICAL FIELD

The present invention relates to a debugging technique that can efficiently execute a debugging process for a distributed parallel program in which many processes are executed.

### BACKGROUND ART

Conventionally, as a method of debugging a program as a related art, there is a tracing method in which a special code is previously embedded in a program to record a processing content, and after the execution of the program, a flow of the process is acquired from a historical data of the recorded process.

Also, a debugging system is well known that is designed to collect only a process data of the process specified by a user who uses a process name, a process ID, or a process number.

The debugging apparatus described in a first related art (Japanese Patent Application Publication (JP-P2000-172528A)) is designed to collect only the process data of the process specified by the user using the process number and convert the collected process data into a format, by using which it can be easily understood to the user (in the collected process data, the process states represented by numerals 1 and 2 are converted into character strings of RUN, READY, which can be understood by the user).

Also, the debugging apparatus described in a second related art (Japanese Patent Application Publication (JP-P2003-256161A)) is designed to collect the process data of the process specified by the user using the process name or process ID and further store only the item in the collected process data, which is specified by the user, in a log file.

The related art tracing method of embedding a special code in a program can determines the validity of the individual content to be processed in each process. However it is difficult to determine a flow of processing between the processes. In particular, when a distributed parallel program is executed in a large-scaled system, a trace amount to be recorded is enormous, and the targeted trace is required to be searched from it. Thus, the debugging process cannot be executed efficiently.

Also, according to the debugging apparatus described in the first and second related arts, it is possible to collect only the process data of the process specified by the user. Thus, if the process data of the process that is required for a debugging is known in advance, it is possible to efficiently execute the debugging process. However, if the process data of the process that is required for the debugging is not known in advance because the number of processes to be executed is great as in the execution of the distributed parallel program in the large-scaled system, it is impossible to efficiently execute the debugging process.

### SUMMARY

It is therefore an object of the present invention to efficiently execute a debugging process even when process data of a process that is required for the debugging is not known in advance because the number of processes to be executed is large.

In an exemplary aspect of the present invention, a debugging system includes a plurality of computers. Each of the plurality of computers includes a process data storage section; and a debug control section configured to collect process data of a process executed on the computer and to store the process data in the process data storage section of the computer. One of the plurality of computers as a specific computer includes a searching section configured to search satisfactory process data, which meets a search condition designated by a user, of the process data stored in the process data storage sections of the plurality of computers, and to display the satisfactory process data on a display unit.

In another exemplary aspect of the present invention, a debugging method in a debugging system including a plurality of computers containing a specific computer is provided. The debugging method includes collecting process data of a process executed on each of the plurality of computers; searching by the specific computer, satisfactory process data meeting a search condition from the process data held by the plurality of computers; and displaying the satisfactory process data on a display unit.

In a still another exemplary aspect of the present invention, a computer-readable software product is provided in which a program to be executed on each of a plurality of computers is written and comprises codes for realizing a debugging method. The debugging method includes collecting process data of a process executed on the computer in response to a collection request; searching satisfactory process data meeting a search condition which is related to the collection request, from the process data collected by the plurality of computers; and displaying the satisfactory process data on a display unit.

### BRIEF DESCRIPTION OF DRAWINGS

The above and other objects, advantages and features of the present invention will be more apparent from the following description of certain exemplary embodiments taken in conjunction with the accompanying drawings, in which:

FIG. 1 is a block diagram showing a configuration of a debugging system according to a first exemplary embodiment of the present invention;

FIG. 2 is a flowchart showing an operation of a debug control section;

FIG. 3 is a diagram showing a content of a process data storage section;

FIG. 4 is a flowchart showing an operation of a searching section;

FIG. 5 is a block diagram showing a configuration of the debugging system according to a second exemplary embodiment of the present invention; and

FIG. 6 is a flowchart showing an operation of the searching section.

### EXEMPLARY EMBODIMENTS

Hereinafter, a debugging system according to exemplary embodiments of the present invention will be described in detail with reference to the attached drawings.

### First Exemplary Embodiment

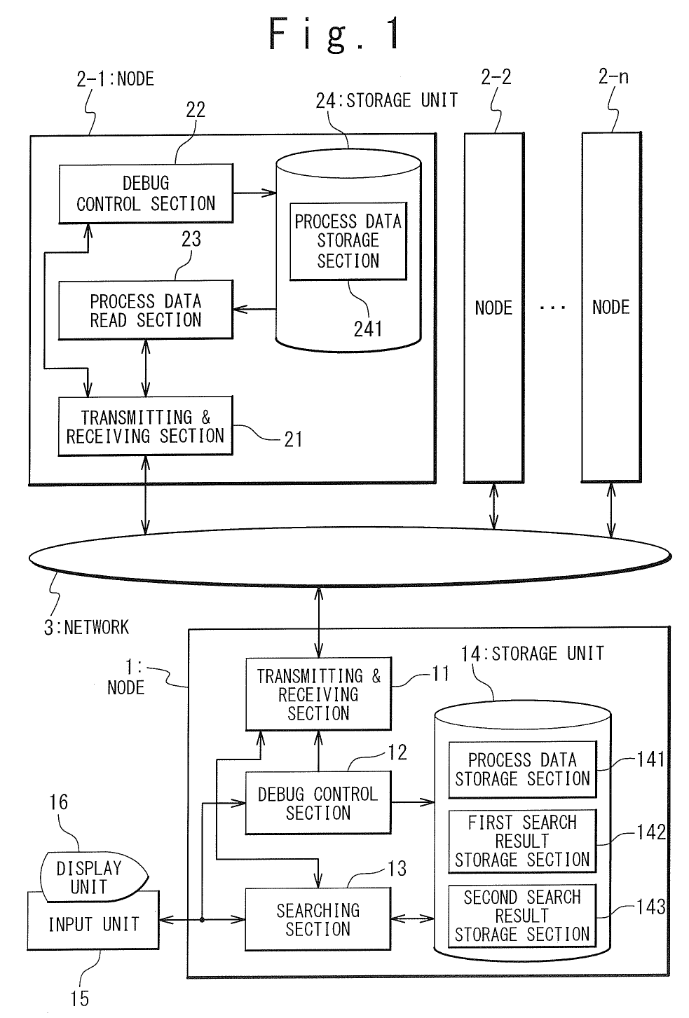

With reference to FIG. 1, the debugging system according to a first exemplary embodiment of the present invention is provided with a plurality of nodes (computers) 1, 2-1 to 2-n connected to each other through a network 3 to execute a distributed parallel program.

The node 1 has a function of instructing other nodes 2-1 to 2-n to collect process data and acquiring the process data collected by the other nodes 2-1 to 2-n, and the other functions. The node 1 contains a transmitting/receiving section 11, a debug control section 12, a searching section 13, a storage unit 14, an input unit 15 such as a keyboard, and a display unit 16 such as an LCD. It should be noted that in the following description, there is a case that the node 1 is referred as a particular node.

The storage unit 14 is composed of a disc apparatus and the like and contains a process data storage section 141, a first search result storage section 142 and a second search result storage section 143. The transmitting/receiving section 11 has a function of transmitting and receiving a data through the network 3.

The debug control section 12 has a function of collecting the process data of a process executed on a self-node and storing it in the process data storage section 141, and a function of transmitting various instructions such as a process data collection instruction to the other nodes 2-1 to 2-n.

The searching section 13 has a function of transmitting a process data acquisition request to the other nodes 2-1 to 2-n when a search request including a search condition is received from the input unit 15, a function of storing in the process data storage section 141, the process data which are received from the other nodes 2-1 to 2-n in response to the process data acquisition request; a function of searching satisfactory process data which satisfy the search condition, from the process data stored in the process data storage section 141; a function of displaying the satisfactory process data on the display unit 16; and a function of storing the searched process data in the first search result storage section 142. Moreover, the searching section 13 has a function of searching new satisfactory process data which satisfy a new search condition, from the search result stored in the first search result storage section 142, when a confining search request including the new search condition is received from the input unit 15; a function of displaying the new satisfactory process data on the display unit 16; and a function of storing the new satisfactory process data in the second search result storage section 143.

It should be noted that the transmitting/receiving section 11, the debug control section 12 and the searching section 13 may be attained by using CPU (central Processing Unit). When they are attained by using the CPU, a disc, a semiconductor memory and the other recording medium may be used, in which is recorded a program for instructing the CPU to attain the functions of the transmitting/receiving section 11, the debug control section 12 and the searching section 13, and to read the program. The CPU controls its operation in accordance with the read program and attains the transmitting/receiving section 11, the debug control section 12 and the searching section 13 on the self-CPU.

The node 2-1 has a function of collecting process data of a process to be executed on the self-node 2-1 in response to an instruction from the particular node 1 and transmitting the collected process data to the particular node 1, and the other functions. The node 2-1 includes a transmitting/receiving section 21, a debug control section 22, a process data read section 23 and a storage unit 24. It should be noted that the other nodes 2-2 to 2-n have the configuration similar to that of the node 2-1.

The storage unit 24 is attained by a disc apparatus and the like, and has a process data storage section 241. The transmitting/receiving section 21 has a function of transmitting and receiving a data through the network 3.

The debug control section 22 has a function of collecting the process data of a process to be executed on the node 2-1 in response to a process data collection instruction from the particular node 1 and storing it in the process data storage section 241.

The process data read section 23 has a function of responding to the process data acquisition request from the particular node 1 to read the process data from the process data storage section 241 and to transmit the process data to the particular node 1.

It should be noted that the transmitting/receiving section 21, the debug control section 22 and the process data read section 23 can be attained by using CPU. When they are attained by using the CPU, a disc, a semiconductor memory and the other recording medium are used, in which is recorded a program for instructing the CPU to attain the functions of the transmitting/receiving section 21, the debug control section 22 and the process data read section 23, and to read the program. The CPU controls its operation based on the read program and attains the transmitting/receiving section 21, the debug control section 22 and the process data read section 23 on the self-CPU.

Next, the operation of the debugging system in the first exemplary embodiment will be described below in detail.

At first, a user uses the input unit 15 of the particular node 1 to input a process data collection instruction. This process data collection instruction contains a collection condition (for example, a breakpoint) of the process data.

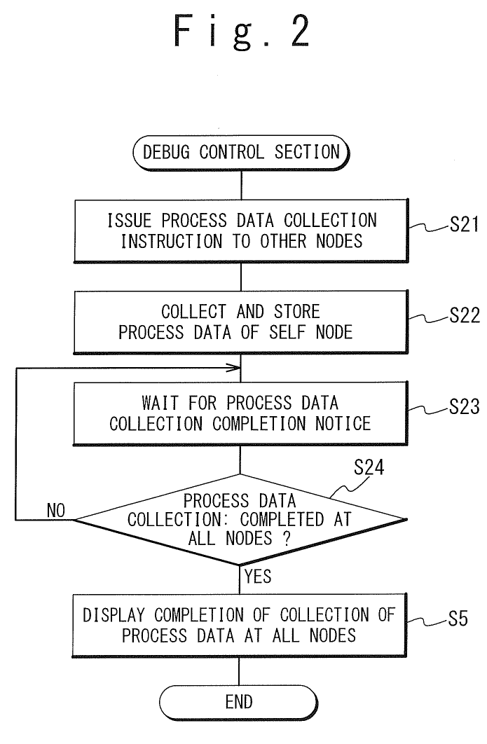

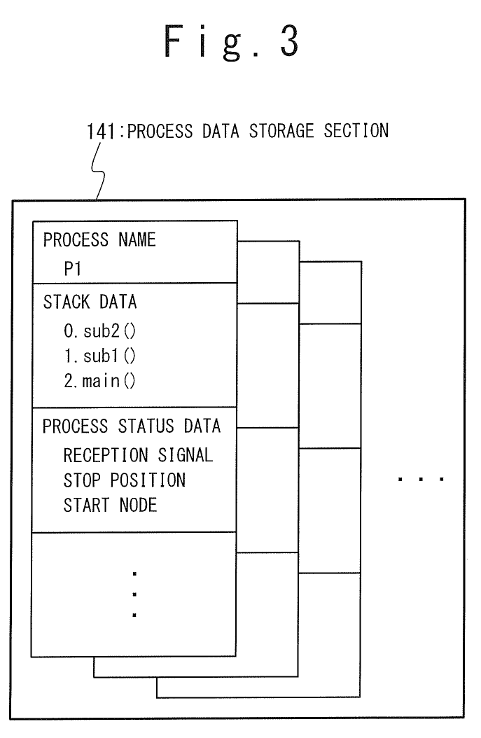

At first, the debug control section 12 on the particular node 1 transmits the process data collection instruction to the other nodes 2-1 to 2-n, as shown by a flowchart in FIG. 2, when the process data collection instruction is received (Step S21). Then, the node 1 executes the distributed parallel program until the breakpoint, and the debug control section 12 collects the process data of the processes executed on the node 1, and stores in the process data storage section 141 as shown in FIG. 3 (Step S22). After that, the debug control section 12 is set to a state to wait for a process data collection completion notice (Step S23). With reference to FIG. 3, the process data includes a stack data, a process state data, a process name of the process in which the process data is collected. The process state data includes a reception signal, a stop position and a start node.

On the other hand, the debug control section 22 on each of the nodes 2-1 to 2-n executes the distributed parallel program until the breakpoint, when the process data collection instruction is received from the particular node 1, and collects the process data of the process to be executed in the node 2-1 to 2-n. The debug control section 22 stores the process data in the process data storage section 241. After that, the debug control section 22 transmits the process data collection completion notice to the particular node 1.

When receiving the process data collection completion notice, the debug control section 12 determines whether or not the collections of the process data in all of the other nodes 2-1 to 2-n have been completed (Step S24).

The debug control section 12 determines that there is a node in which the collection of the process data has not yet been completed (Step S24; NO), the process flow returns to the state to wait for the process data collection completion notice (Step S23). On the contrary, if the debug control section 12 determines that the collections of the process data in all of the other nodes 2-1 to 2-n have been completed (Step S24; YES), the completion of the collection of the process data in all the nodes 2-1 to 2-n is displayed on the display unit 16 (Step S25).

The user looks at this display and recognizes the completion of the collections of the process data in all of the nodes 1, 2-1 to 20n. Then, the user inputs a search request from the input unit 15. The search request includes a search condition, which must be met by the process data used for the debugging. As the search condition, there are a reception signal of the process, a stop position of the process, an invoking function included in the stack data, a start node of the process, and the like.

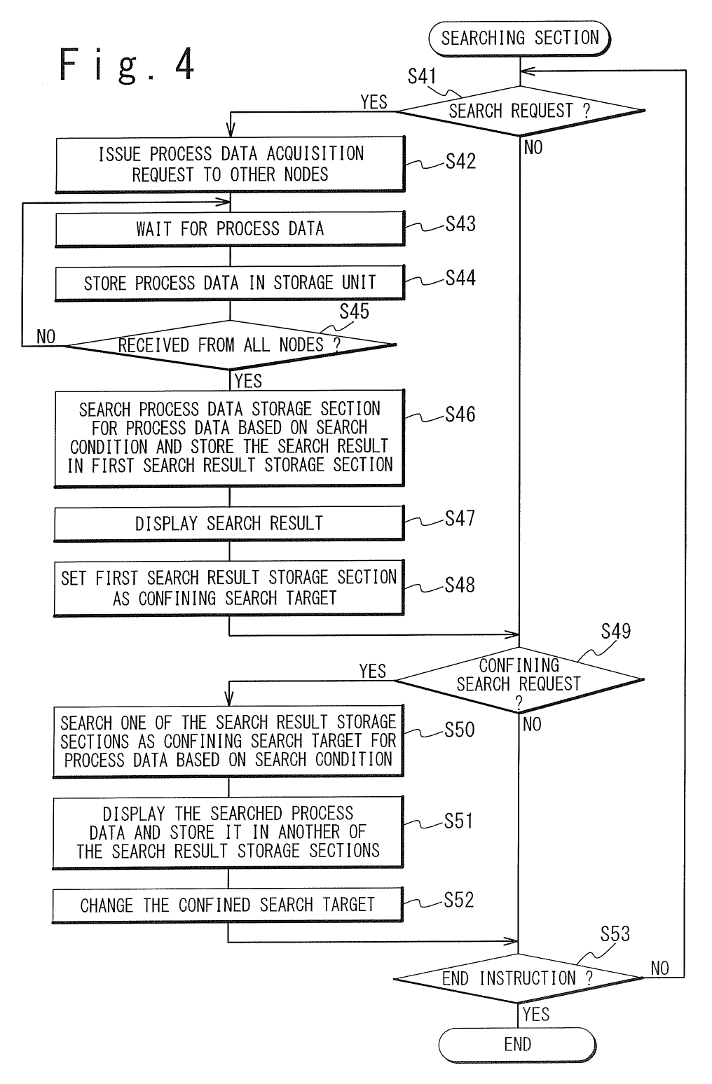

As shown by the flowchart of FIG. 4, when the search request is received from, for example, a user (Step S41; YES), the searching section 13 transmits a process data acquisition request to the other nodes 2-1 to 2-n (Step S42), and then is set to a state to wait for the reception of the process data (Step S43).

On the other hand, when the process data acquisition request is received from the particular node 1, the process data read section 23 on each of the nodes 2-1 to 2-n reads the process data stored in the process data storage section 241 on the node 2-1 to 2-n and transmits it to the particular node 1.

When the process data is received from the node 2-i (1·i·n), the searching section 13 on the particular node 1 stores it in the process data storage section 141 (Step S44) and then determines whether or not the process data from all the nodes 2-1 to 2-n are received (Step S45). If the searching section 13 determines that there is the node which does not yet receive the process data (Step S45; NO), the process flow returns to the step S43. On the contrary, if the process data from all the nodes 2-1 to 2-n are determined to be received (Step S45; YES), the process data meeting the search condition is searched from the process data stored in the process data storage section 141 and stored in the first search result storage section 142 (Step S46). After that, the searching section 13 displays a search result on the display unit 16 (Step S47). Moreover, when the confining search request is received, the searching section 13 sets a confining search target data indicating one of the first and second search result storage sections 142 and 143 to that indicating the first search result storage section 142 in which the newest search result is stored (Step S48).

Now, for example, when it is supposed that the content of the process data storage section 141 is as shown in FIG. 3 and the search condition included in the search request is [the process data in which an invoking function sub1( ) is included in the stack data], the process data of a process name [P1] is searched.

When viewing the process data (the search request) displayed on the display unit 16 and desiring to confine the process data used for the debugging, the user issues a confining search request from the input unit 15. Also, the search condition is included in the confining search request.

When the confining search request is received (Step S49; YES), the searching section 13 searches the process data which satisfies the search condition, from the process data stored in the search result storage section indicated by the confining search target data, as one of the first and second search result storage sections 142 and 143, and displays the searched process data on the display unit 16. The searching section 13 stores the searched process data in the other search result storage section (Steps S50 and S51). After that, the searching section 13 changes the confined search target data (Step S52).

Now, it is supposed that when the confining search target data indicates the first search result storage section 142, the confining search request is received. The searching section 13 searches the process data which satisfy the search condition, from the process data stored in the first search result storage section 142 at the step S50, and displays the searched process data on the display unit 16 at the step S51, and also stores in the second search result storage section 143 and changes the confining search target data to that indicating the second search result storage section 143 at the step S52.

The user receives an end instruction from the input unit 15, when the debugging has been ended. When the end instruction is received (Step S53; YES), the searching section 13 ends the process.

According to this exemplary embodiment, even when the number of processes to be executed is so large that a process data mount of the processes necessary for the debugging cannot be known in advance, the debugging process can be efficiently executed. This reason is as follows. That is, the respective nodes 1 and 2-1 to 2-n execute the distributed parallel program and store the process data of the processes which have been executed on the nodes 1, 2-1 to 2-n, in the process data storage sections 141 and 241 of the nodes 1 and 2-1 to 2-n. The searching section 13 on the particular node 1 searches the process data which satisfy the search condition specified by the user, from the process data stored in the process data storage sections 141 and 241 of the respective nodes 1 and 2-1 to 2-n. That is, the debugging limited to a process group satisfying the condition specified by the user can be executed, thereby allowing the efficient execution of the debugging process.

### Second Embodiment

The debugging system according to a second exemplary embodiment of the present invention will be described below. In the second exemplary embodiment, when each node transmits the process data to the particular node, only the process data satisfying the search condition specified by the particular node is transmitted.

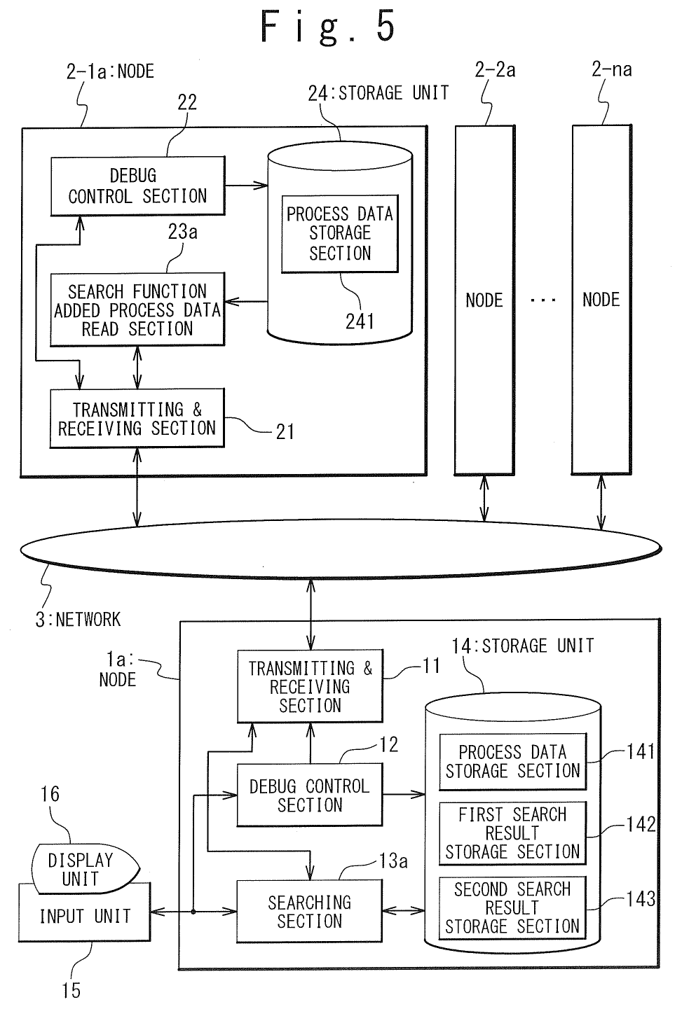

With reference to FIG. 5, the second exemplary embodiment of the present invention is provided with a plurality of nodes 1a and 2-1a to 2-na for executing the distributed parallel program, and the respective nodes 1a and 2-1a to 2-na are connected to each other through the network 3.

The node 1a in the second exemplary embodiment differs from the node 1 shown in FIG. 1 in that the node 1a contains a searching section 13a instead of the searching section 13. It should be noted that the same reference numerals or symbol as those in FIG. 1 are assigned to the same components. Also, in the following description, there is a case that the node 1a is referred to as the particular node.

The searching section 13a has a function of transmitting the process data acquisition request including the search condition to the other nodes 2-1a to 2-na when the search request including the search condition is received from the input unit 15; a function of displaying on the display unit 16, the process data which are received from the respective nodes 2-1a to 2-na in response to the process data acquisition request, and storing in the first search result storage section 142; and a function of searching the process data which satisfy the search condition, from the process data stored in the process data storage section 141. It should be noted that the transmitting/receiving section 11, the debug control section 12 and the searching section 13a can be attained by instructing the CPU to execute a predetermined program.

The node 2-1a differs from the node 2-1 shown in FIG. 1 in that the node 2-1a contains the search function added process data read section 23a instead of the process data read section 23. It should be noted that the same reference numerals or symbols as those of FIG. 1 are assigned to the same components. Also, the other nodes 2-2a to 2-na have the same components as those of the node 2-1a. When the process data acquisition request including the search condition is issued from the particular node 1a, the search function added process data read section 23a searches the process data which satisfy the search condition, from the process data stored in the process data storage section 241 and transmits the searched process data to the particular node 1a. It should be noted that the transmitting/receiving section 21, the debug control section 22 and the search function added process data read section 23a can be attained by instructing the CPU to execute the predetermined program.

The operation of the debugging system in the second exemplary embodiment will be described below. The difference of the second exemplary embodiment from the first exemplary embodiment is in only the operation when the search request is received. Thus, only the operation in this case will be described.

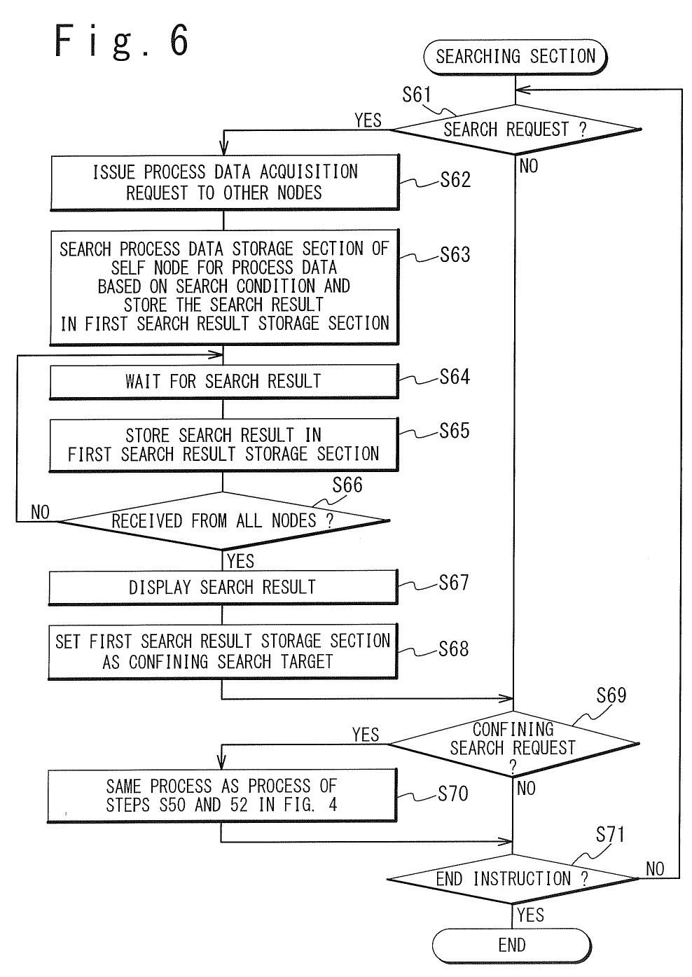

If the user inputs a search request that includes the search condition, from the input unit 15 in the particular node 1a (Step S61 in FIG. 6; YES), the searching section 13a transmits the process data acquisition request that includes the search condition, to the other nodes 2-1a to 2-na (Step S62). Subsequently, the searching section 13a searches the process data that satisfy the search condition from the process data storage section 141 on the node 1a and then stores in the first search result storage section 142 (Step S63). After that, the searching section 13a is set to a state to wait for a search request reception (Step S64).

On the other hand, the search function added process data read section 23a on each of the nodes 2-1a to 2-na receives the process data acquisition request including the search condition from the particular node 1a, searches the process data which satisfy the search condition, from the process data storage sections 241 on the node 2-1a to 2-na, and transmits the searched process data to the particular node 1a.

When the search result is received from the node 2-ja (0·j·n), the searching section 13a stores it in the first search result storage section 142 (Step S65), and determines whether or not the search results are received from all of the nodes 2-1a to 2-na (Step S66). If the searching section 13a determines that there is the node which does not yet receive the search result (Step S66; NO), the process flow returns to the step S64. On the contrary, if the search results are determined to be already received from all the nodes 2-1a to 2-na (Step S66; YES), the search result (the process data) stored in the first search result storage section 142 is displayed on the display unit 16 (Step S67). After that, a confining search target data is changed to a data indicating the first search result storage section 142 in which the newest search result is stored (Step S68). It should be noted that if the confining search request is received (Step S69; YES), the processes similar to those of the steps S50 to S52 in FIG. 4 are executed (Step S70), and if the end instruction is received (Step S71; YES), the process is ended.

According to the second exemplary embodiment, each of the nodes 2-1a to 2-na contains the search function added process data read section 23a. When the process data acquisition request including the search condition is received from the particular node 1a, only the process data satisfying the search condition is transmitted. Thus, the load on the particular node 1a can be reduced.

It is preferable to apply to the debugging process for the distributed parallel program in the large scale system.

According to the present invention, it is possible to efficiently execute the debugging process even when the process data of the process that is required for the debugging examination is not known in advance because the number of the processes to be executed is great. This is because each computer for executing the distributed parallel program and the like stores the process data of the process, which is executed in the self-computer, in a process data storage section on the self-computer, and a searching section on a particular computer retrieves the process data, which satisfies the search condition specified by a user, from the process data stored in the process data storage section in each computer. That is, the debugging examination limited to the process group that satisfies the condition specified by the user can be executed, which enables the efficient execution of the debugging process.

Although the inventions has been described above in connection with several exemplary embodiments thereof, it will be appreciated by those skilled in the art that those exemplary embodiments are provided solely for illustrating the invention, and should not be relied upon to construe the appended claims in a limiting sense.

What is claimed is:

1. A debugging system comprising a plurality of computers, each of which comprises:
a process data storage section; and
a debug control section configured to collect process data of a process executed on said computer and to store the process data in said process data storage section of said computer,
wherein one of said plurality of computers as a specific computer comprises:
a searching section configured to search satisfactory process data, which meets a search condition designated by a user, of the process data stored in said process data storage sections of said plurality of computers, and to display the satisfactory process data on a display unit.

2. The debugging system according to claim 1, wherein each of the other computers of said plurality of computers other than said specific computer comprises:
a process data read section configured to read the process data from said process data storage section to transmit to said specific computer, in response to a process data acquisition request from said specific computer, and
said searching section issues the process data acquisition request to the other computers, searches the satisfactory process data from the process data transmitted from the other computers and the process data stored in said process data storage section of said specific computer, and display the satisfactory process data on said display unit.

3. The debugging system according to claim 1, wherein each of the other computers of said plurality of computers other than said specific computer comprises:
a process data read section configured to read the satisfactory process data, meeting the search condition, from said process data storage section to transmit to said specific computer, in response to a process data acquisition request containing the search condition and issued from said specific computer, and
said searching section issues the process data acquisition request to the other computers, searches the satisfactory process data from the process data stored in said process data storage section of said specific computer, and display the satisfactory process data searched by said searching section and the satisfactory process data transmitted from the other computers on said display unit.

4. The debugging system according to claim 2, wherein said specific computer further comprises a search result storage section, and
wherein said searching section stores in said search result storage section, the satisfactory process data which are searched from the process data transmitted from the other computers and the process data stored in said process data storage section of said specific computer, searches new satisfactory process data meeting a new search condition from the satisfactory process data, stored in said search result storage section, in response to a confining search request containing the new search condition, and display the new satisfactory process data on said display unit.

5. The debugging system according to claim 3, wherein said specific computer further comprises a search result storage section, and
wherein said searching section stores in said search result storage section, the satisfactory process data transmitted from the other computers and the satisfactory process data searched from the process data stored in said process data storage section of said specific computer, searches new satisfactory process data meeting a new search condition from the satisfactory process data, stored in said search result storage section, in response to a confining search request containing the new search condition, and display the new satisfactory process data on said display unit.

6. A debugging method in a debugging system which comprises a plurality of computers containing a specific computer, said debugging method comprising:
collecting process data of a process executed on each of said plurality of computers;
searching by said specific computer, satisfactory process data meeting a search condition from the process data held by said plurality of computers; and
displaying the satisfactory process data on a display unit.

7. The debugging method according to claim 6, wherein said searching comprises:
issuing a process data acquisition request from said specific computer to the other computers of said plurality of computers other than said specific computer;
transmitting the process data from the other computers to said specific computer in response to the process data acquisition request;
searching the satisfactory process data from the process data transmitted from the other computers and the process data held by said specific computer.

8. The debugging method according to claim 6, wherein said searching comprises:
issuing a process data acquisition request containing the search condition from said specific computer to the other computers of said plurality of computers other than said specific computer;
transmitting the satisfactory process data meeting the search condition to said specific computer in response to a process data acquisition request; and
searching the satisfactory process data from the process data held said specific computer.

9. The debugging method according to claim 7, wherein said searching further comprising:
storing in a search result storage section, the satisfactory process data which have been searched from the process data transmitted from the other computers and the process data held by said specific computer; and
searching new satisfactory process data meeting a new search condition from the satisfactory process data stored in said search result storage section, in response to a confining search request containing the new search condition, and
said displaying comprises:
displaying the new satisfactory process data on said display unit.

10. The debugging method according to claim 8, wherein said searching comprises:
storing in a search result storage section, the satisfactory process data transmitted from the other computers and the satisfactory process data searched from the process data held by said specific computer; and
searching new satisfactory process data meeting a new search condition from the satisfactory process data stored in said search result storage section, in response to a confining search request containing the new search condition, and
said displaying comprises:
displaying the new satisfactory process data on said display unit.

11. A computer-readable software product in which a program to be executed on each of a plurality of computers is written and comprises codes for realizing a debugging method, said debugging method comprising:
collecting process data of a process executed on said computer in response to a collection request;
searching satisfactory process data meeting a search condition which is related to said collection request, from the process data collected by said plurality of computers; and
displaying the satisfactory process data on a display unit.

12. The computer-readable software product according to claim 11, wherein said searching comprises:
issuing a process data acquisition request;
receiving the process data transmitted from the other computers in response to the process data acquisition request; and
searching the satisfactory process data from the received process data and the process data held by said computer.

13. The computer-readable software product according to claim 11, wherein said searching comprises:
issuing a process data acquisition request containing the search condition;
searching the satisfactory process data meeting the search condition from the process data held by said computer in response to a process data acquisition request;
transmitting the satisfactory process data to an issuing source of the process data acquisition request; and
receiving the satisfactory process data meeting the search condition in response to a process data acquisition request.

14. The computer-readable software product according to claim 12, wherein said searching further comprising:
storing in a search result storage section, the satisfactory process data which have been searched from the process data received from the other computers and the process data held by said computer; and
searching new satisfactory process data meeting a new search condition from the satisfactory process data stored in said search result storage section, in response to a confining search request containing the new search condition, and
said displaying comprises:
displaying the new satisfactory process data on said display unit.

15. The computer-readable software product according to claim 13, wherein said searching comprises:
storing in a search result storage section, the satisfactory process data received from the other computers and the satisfactory process data searched from the process data held by said computer; and
searching new satisfactory process data meeting a new search condition from the satisfactory process data stored in said search result storage section, in response to a confining search request containing the new search condition, and
said displaying comprises:
displaying the new satisfactory process data on said display unit.
